(19) United States
(12) Patent Application Publication
(10) Pub. No.: US 2018/0338507 A1
(43) Pub. Date: Nov. 29, 2018

(54) MINERAL TREATED ALKALINE COLD-BREWED COFFEE PROCESS

(71) Applicant: Adam Earl Westmoreland, Huntington Beach, CA (US)

(72) Inventor: Adam Earl Westmoreland, Huntington Beach, CA (US)

(21) Appl. No.: 15/978,510

(22) Filed: May 14, 2018

Related U.S. Application Data
(60) Provisional application No. 62/511,227, filed on May 25, 2017.

(51) Int. Cl. A23F 5/22; A23F 5/26

(52) U.S. Cl. CPC A23F 5/22; A47J 31/40; A23F 5/26

(57) ABSTRACT

A method for cold-brewing a non-acidic coffee product may include adding minerals to water, creating mineralized water; brewing an alkaline coffee product using the mineralized water; and removing coffee grounds from the alkaline coffee product. The brewing step may be a cold-brewing step including soaking coffee in the mineralized water for a desired period of time, such as from about 8 to about 24 hours. The minerals may be carbonate compounds or any other compound capable of raising the pH level of the water to be greater than 7 prior to brewing. The resulting product may be a non-acidic coffee product.

### RELATED APPLICATION

This application claims priority to provisional patent application U.S. Ser. No. 62/511,227 filed on May 25, 2017, the entire contents of which is herein incorporated by reference.

### BACKGROUND

The embodiments herein relate generally to cold brewed coffee processes, and more particularly, to a mineral treated alkaline cold-brewed coffee process.

Existing methods of brewing coffee result in an acidic product. The acidity of coffee can cause many physiological problems, such as damage to the gastrointestinal tract and teeth.

Moreover, the natural acids extracted from coffee can denature a portion of the caffeine extracted during as well as following the brewing process. Specifically, when coffee is brewed by traditional methods, the natural acids that exist in the coffee beans can cause a portion of the caffeine content to be changed into an inactive form during and following the extraction process.

Therefore, what is needed is a method of brewing, and particularly cold-brewing, coffee that results in an alkaline product with more stable caffeine levels.

### SUMMARY

Some embodiments of the present disclosure include a method for cold-brewing a non-acidic coffee product. The method may include adding minerals to water, creating mineralized water; brewing an alkaline coffee product using the mineralized water; and removing coffee grounds from the alkaline coffee product. The brewing step may be a cold-brewing step including soaking coffee in the mineralized water for a desired period of time, such as from about 8 to about 24 hours. The minerals may be carbonate compounds or any other compound capable of raising the pH level of the water to be greater than 7 prior to brewing. The resulting product may be a non-acidic coffee product.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The method of the present disclosure may be used as a conductive hot glue and may comprise the following elements. This list of possible constituent elements is intended to be exemplary only, and it is not intended that this list be used to limit the method of the present application to just these elements. Persons having ordinary skill in the art relevant to the present disclosure may understand there to be equivalent elements that may be substituted within the present disclosure without changing the essential function or operation of the method.

a. Adding minerals to water

b. Soaking coffee grounds in water

c. Removing grounds

The various elements of the method of the present disclosure may be related in the following exemplary fashion. It is not intended to limit the scope or nature of the relationships between the various elements and the following examples are presented as illustrative examples only.

By way of example, some embodiments of the present disclosure include a method of brewing coffee, resulting in a non-acidic cold-brewed coffee, the method comprising treating water with minerals to increase a pH level of the water before brewing; allowing the minerals to dissolve into the water, creating mineralized water; adding a volume of coffee to the mineralized water for a desired amount of time creating an alkaline cold-brewed coffee, wherein the desired amount of time may depend on the desired strength of a final coffee product; and removing coffee grounds from the alkaline cold-brewed coffee. The method may further comprise testing the pH and electrical conductivity (TDS) of the water before brewing to ensure a suitable level of each. Similarly, the pH and TDS of the cold brew coffee may also be tested after the grounds have been removed to track extraction. Adding more coffee or allowing a longer brewing time may extract more natural acids, resulting in a larger drop of pH of the resulting coffee.

Proper water treatment is important in a successful extraction using the method of the present disclosure. The water needs to be treated with enough minerals such that it can effectively neutralize any acidity extracted from the coffee during the brewing process without saturating the water to the point that it will not extract an ample amount of molecules from the coffee. Moreover, adding too high of a concentration of minerals prior to adding the coffee will result in very weak coffee having a high pH. On the other hand, not adding enough minerals may result in an adequately strong cold-brewed coffee, but it may have a pH less than 7. Thus, using the proper minerals and the correct concentration of the minerals may be important. However, the concentration and proper minerals may vary depending on the characteristics of the coffee used, as well as ay interaction restrictions that a filter (if used) may cause between the aqueous solution and the coffee grounds.

Suitable minerals that may be added to the water prior to brewing may include any mineral capable of raising the pH of water above 7. For example, suitable minerals include carbonate compounds, such as potassium carbonate (K₂CO₃), potassium bicarbonate (KHCO₃), sodium bicarbonate (NaHCO₃), other compounds, such as magnesium sulfate (MgSO₄), and a combination thereof. When the minerals are added to the water, the dissolved ions in the water rise and, unlike water ionizers, a pH well above 7 that can be maintained long term will be established. The addition of the minerals before the brewing process may serve a dual purpose. First, it established alkalinity in the water due to the nature of the molecules and their subsequent reaction with water to take-on protons from the water molecules, resulting in a higher concentration of hydroxyl ions. Second, the now alkaline aqueous solution creates a more stable environment for the caffeine molecules, resulting in a more efficient caffeine extraction.

In a particular embodiment, potassium carbonate may be added to the water prior to brewing. The potassium carbonate dissociates in water into two potassium ions and a reaction carbonate ion. The carbonate ion goes on to react with two water molecules to create carbonic acid and two hydroxyl ions, which raise the pH of the water solution.

As mentioned above, the amount of coffee added to the mineralized water and the length of time the coffee is allowed to brew may depend on the desired strength of the resulting final coffee product. For example, the amount of coffee added may be from about 0.25 to about 2.0 pounds of coffee per gallon of water, and the brew time may be from about 8 to about 36 hours.

The method of the present disclosure may be a cold-brew process, meaning that the coffee is brewed at or below room temperature. The resulting product may be a full-bodied cold brew concentrate having a pH greater than 7 that will both maintain an alkaline pH when bottled and distributed and extract caffeine more efficiently than normal cold-brew processes.

Removing the coffee grounds from the cold-brew coffee may be done using any known methods.

By treating the water with minerals before brewing, the natural acids extracted by the coffee are neutralized during the brewing process, resulting in a product that is alkaline (non-acidic) and has a pH level greater than 7. With a final product have a pH greater than 7, the acidity is completely neutralized, and the problems caused by the acidity are eliminated. Additionally because caffeine is categorized as an alkaloid, it is more stable in an alkaline solution and very little, if any, will be denatured during or after the brewing process.

While the method is described above as adding minerals to the water prior to brewing, in some embodiments the cold-brew coffee may be brewed and then minerals may be added. While this would result in a less efficient caffeine extraction, an alkaline product may still be obtained. However, adding the minerals after brewing may also cause the minerals to react adversely in a number of side reactions that may jeopardize the quality of the product, due to the abundance of different organic and inorganic compounds contained within coffee. Instead of allowing the totality of the dissolved minerals to establish the alkalinity of the water, the minerals may react in a number of ways with the complex molecules extracted from the coffee, which may vary greatly base on the individual characteristics and composition of the coffee used. This may thus require more of the minerals to establish an equivalent alkalinity as would be needed by treating the water prior to the brewing process.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A method for brewing a non-acidic coffee product, the method comprising:
adding minerals to water, creating mineralized water;
brewing an alkaline coffee product using the mineralized water; and
removing coffee grounds from the alkaline coffee product,
wherein the alkaline coffee product is non-acidic.

2. The method of claim 1, wherein brewing the alkaline coffee product comprises a cold-brew method.

3. The method of claim 2, wherein the cold-brew method comprising adding coffee to the mineralized water and allowing the coffee to soak for a desired amount of time, creating an alkaline coffee product.

4. The method of claim 3, wherein the desired amount of time is from about 8 to about 24 hours.

5. The method of claim 1, wherein the minerals are added to the water until a pH level is greater than 7.

6. The method of claim 1, further comprising testing a pH and TDS level of the mineralized water prior to brewing the alkaline coffee product.

7. The method of claim 1, further comprising testing a pH and TDS level of the alkaline coffee product after the coffee grounds are removed.

8. The method of claim 1, wherein the minerals comprise a carbonate compound.

9. The method of claim 1, wherein the minerals are selected from a group consisting of potassium carbonate, potassium bicarbonate, sodium bicarbonate, and magnesium sulfate.

10. A method for cold-brewing a non-acidic coffee concentrate, the method comprising:
adding minerals to water until a pH level of the water is greater than 7, creating a mineralized water, wherein the minerals are selected from the group consisting of potassium carbonate, potassium bicarbonate, sodium bicarbonate, and magnesium sulfate;
adding coffee to the mineralized water and allowing the coffee to soak for a desired amount of time, creating a non-acidic coffee concentrate; and
removing coffee grounds from the non-acidic coffee concentrate,
wherein a pH level of the non-acidic coffee concentrate is greater than 7.
